(19) United States
(12) Patent Application Publication
(10) Pub. No.: US 2016/0326010 A1
(43) Pub. Date: Nov. 10, 2016

(54) DEVELOPMENT OF NICKEL FERRITES AND METHODS FOR PREPARING SAME USING STEEL INDUSTRY BY-PRODUCT IRON OXIDE FINES

(71) Applicant: SABIC GLOBAL TECHNOLOGIES BV, Amsterdam (NL)

(72) Inventors: Fazal-ur-Rehman Awan, Al-Jubail (SA); Mahmoud Mohamed Hessien, Taif (SA); Hesham Hanafy, Al-Jubail (SA)

(21) Appl. No.: 15/108,910

(22) PCT Filed: Jan. 13, 2015
(86) PCT No.: PCT/IB2015/050252

§ 371 Date: Jun. 29, 2016

Related U.S. Application Data
(60) Provisional application No. 61/928,680, filed on Jan. 17, 2014.

(51) Int. Cl. C01G 49/00; H01F 1/34; C01G 53/00

(52) U.S. Cl. CPC C01G 49/0018; C01G 53/40; H01F 1/344; C01P 2006/42; C01P 2002/72; C01P 2002/85; C01P 2004/03

(57) ABSTRACT

Method for preparing soft cubic ferrites of a general formula MFe₂O₄ comprising the steps of contacting an iron containing by-product of iron ore processing and a metal oxide of the general formula MₓO_{y}, to form a mixture, wherein the stoichiometric ratio of M to iron is in the range from greater than zero to about 2, and wherein M is nickel, magnesium, or zinc, or a combination thereof; and calcining the mixture at a temperature range of from about 1000° C. to about 1500° C. in a static air atmosphere, to form a soft cubic ferrite of a general formula MFe₂O₄, wherein the mixture is not subjected to an oxidation step or a compacting step prior to calcining.

### BACKGROUND

1. Technical Field

The present disclosure relates to nickel ferrite materials and to methods for the preparation thereof.

2. Technical Background

Ferromagnetic oxides, or ferrites as they are frequently known, can be useful as high-frequency magnetic materials due to their large resistivities. Ferrites have become available as practical magnetic materials over the course of the last twenty years. Such ferrites are frequently used in communication and electronic engineering applications and they can embrace a very wide diversity of compositions and properties. Ferrites are ceramic materials, typically dark grey or black in appearance and very hard or brittle. Ferrite cores can be used in electronic inductors, transformers, and electromagnets where high electrical resistance leads to low eddy current losses. Early computer memories stored data in the residual magnetic fields of ferrite cores, which were assembled into arrays of core memory. Ferrite powders can be used in the coatings of magnetic recording tapes. Ferrite particles can be used as a component of radar-absorbing materials in stealth aircrafts and in the expensive absorption tiles lining the rooms used for electromagnetic compatibility measurements. Moreover, common radio magnets, including those used in loudspeakers, can be ferrite magnets. Due to their price and relatively high output, ferrite materials can also be used for electromagnetic instrument pickups.

There are basically two varieties of ferrite: soft (cubic ferrites) and hard (hexagonal ferrites) magnetic applications. Soft ferrites are characterized by the chemical formula MOFe₂O₃, with M being a transition metal element, e.g. iron, nickel, manganese or zinc. Hard ferrites are permanent magnetic materials based on the crystallographic phases BaFe₁₂O₁₉, SrFe₁₂O₁₉, and PbFe₁₂O₁₉. The formulas for these hard ferrite materials can generally be written as MFe₁₂O₁₉, where M can be Ba, Sr, or Pb. The soft ferrites belong to an important class of magnetic materials because of their remarkable magnetic properties particularly in the radio frequency region, physical flexibility, high electrical resistivity, mechanical hardness, and chemical stability.

Soft ferromagnetic oxides (ferrites) can be useful as high-frequency magnetic materials. The general formula for these compounds is MOFe₂O₃ or MFe₂O₄, where M can be a divalent metallic ion such as Fe²⁺, Ni²⁺, Cu²⁺, Mg²⁺, Mn²⁺, Zn²⁺, or a mixture thereof. Soft ferrites can be useful in a broad range of electronic applications in including television deflection yokes and flyback transformers, rotary transformers in video players and recorders, switch-mode power supplies, EMI-RFI (Electromagnetic Interference and Radio Frequency Interference) absorbing materials, and a wide variety of transformers, filters and inductors in electronic home appliances and industrial equipment. A soft ferrite core can exhibit high magnetic permeability which concentrates and reinforces the magnetic field and high electrical resistivity, thus limiting the amount of electric current flowing in the ferrite. Many telecommunication parts, power conversion and interference suppression devices use soft ferrites. Frequently used combinations include manganese and zinc (MnZn) or nickel and zinc (NiZn). These compounds exhibit good magnetic properties below a certain temperature, called the Curie Temperature (Tc). They can easily be magnetized and have a rather high intrinsic resistivity.

Accordingly, there is an ongoing need for new, economical, environmentally friendly, and effective ferrite materials and methods for preparing such ferrite materials. Thus, there is a need to address these and other shortcomings associated with ferrite materials. These needs and other needs are satisfied by the compositions and methods of the present disclosure.

### SUMMARY

In accordance with the purpose(s) of the invention, as embodied and broadly described herein, this disclosure, in one aspect, relates to nickel ferrite materials and methods for the preparation thereof.

In one aspect, the present disclosure provides a method for preparing soft cubic ferrites of a general formula MFe₂O₄ comprising: contacting an iron containing by-product of iron ore processing and a metal oxide of the general formula MₓO_{y} to form a mixture, wherein the stoichiometric ratio of M to iron is in the range from greater than zero to about 2, and wherein M is nickel, magnesium, or zinc, or a combination thereof; and calcining the mixture at a temperature range of from about 1000° C. to about 1,500° C. in a static air atmosphere, to form a soft cubic ferrite of a general formula MFe₂O₄, wherein the mixture is not subjected to an oxidation step or a compacting step prior to calcining.

In another aspect, the present disclosure provides a method for preparing a nickel ferrite comprising: contacting an iron containing by-product of iron ore processing and a nickel oxide; and calcining the mixture at a temperature range of from about 1000° C. to about 1,500° C. in a static air atmosphere, to form a soft cubic ferrite, wherein the mixture is not subjected to an oxidation step or a compacting step prior to calcining.

In another aspect, the present disclosure provides a method for preparing a soft cubic ferrite, wherein an iron containing by product of iron ore processing comprises iron oxide dust.

In yet another aspect, the present disclosure provides a nickel ferrite prepared from the methods described herein.

In still other aspects, the present disclosure provides articles and/or devices comprising nickel ferrites as described herein.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates the X-Ray Diffraction (XRD) pattern for a fine iron oxide material.

FIG. 2 illustrates the XRD pattern for a fine iron oxide material.

FIG. 3 illustrates an exemplary process diagram for the synthesis of NiFe₂O₄ materials by conventional solid state reaction methods.

FIG. 4 illustrates the XRD pattern of NiFe₂O₄ powder produced at a Ni:Fe mole ratio of 1:2.

FIG. 5 illustrates the XRD pattern of NiFe₂O₄ powder produced at a Ni:Fe mole ratio of 1.1:2.

FIG. 6 illustrates scanning electron micrographs (SEM) of crystalline NiFe₂O₄ powders prepared at Ni:Fe=1:2 at various annealing temperatures.

FIG. 7 illustrates scanning electron micrographs of crystalline NiFe₂O₄ powders prepared at Ni:Fe=1.1:2 at various annealing temperatures.

FIG. 8 illustrates microstructure maps for elemental constituents in a nickel ferrite material having a Ni:Fe ratio of 1.1:2 and an annealing temperature of 1,300° C.

FIG. 9 illustrates Energy Dispersive X-Ray (EDX) spot analysis of nickel ferrite power having a Ni:Fe mole ratio of 1.1:2 and an annealing temperature of 1,200° C.

FIG. 10 illustrates the effect of annealing temperature on the M-H hysteresis loop of NiFe₂O₄ powders produced with a Ni:Fe mole ratio of 1:2.

FIG. 11 illustrates the effect of annealing temperature on the M-H hysteresis loop of NiFe₂O₄ powders produced with a Ni:Fe mole ratio of 1.1:2.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a ketone” includes mixtures of two or more ketones.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

References in the specification and concluding claims to parts by weight of a particular element or component in a composition or article denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides improved soft ferrite materials and methods for the manufacture thereof. In one aspect, the methods described herein can utilize by-products from conventional steel industry processes as raw materials in the preparation of soft ferrite materials. Such by-products can contain, in various aspects, high iron content, low impurities, and/or stable chemical compositions. In another aspect, such by-products can be contacted and/or mixed with one or more other metal oxide materials and be subsequently heat treated at various temperatures. In one aspect, the methods described herein can be environmentally friendly, at least with respect to conventional ferrite production methods, by incorporating by-products from iron ore processing or steel industry processes.

In one aspect, the soft ferrite can comprise a soft ferrite, such as, for example, a nickel ferrite, a magnesium ferrite, a zinc ferrite, or a combination thereof. In another aspect, one or more of the raw materials used in the preparation of a soft ferrite can comprise a by-product of iron ore processing, such as, for example, a fine iron oxide dust. In another aspect, the iron containing by-product can comprise, for example, oxide pellet fines from iron ore processing.

The raw materials for preparing a soft ferrite material can comprise an iron oxide, such as for example, a fine iron oxide dust, and a metal oxide, such as, for example, a zinc, magnesium, and/or nickel oxide. In still other aspects, the metal oxide can initially be provided in a form other than the oxide, such that the metal containing compound can be converted to an oxide prior to or during formation of the desired ferrite material.

In one aspect, the iron containing by-product can comprise any suitable iron containing material. In another aspect, the by-product can exhibit an iron content of at least about 50 wt. %, at least about 60 wt. %, or greater. In other aspects. The by-product does not contain significant concentrations of impurities that might adversely affect the preparation of a ferrite or the resulting ferrite material. In one aspect, an iron containing by-product can comprise an iron oxide dust, mill scale, bag house dust, or a combination thereof. Exemplary chemical compositions of such by-products are detailed in Table 1, below. In other aspects, the iron containing by-product can comprise other compositions typical in the steel industry, for example, and not specifically recited in Table 1. In one aspect, the iron containing by-product can comprise an iron oxide dust having a total iron concentration of about 68 wt. %. In another aspect, the iron containing by-product comprises Fe(II), Fe(III), Fe(II/III), or a combination thereof.

TABLE 1
Exemplary Chemical Compositions of
Iron Containing By-Products

| | Wt, % | | | | |
|---|---|---|---|---|---|
| | Oxide | Oxide | | | Bag |
| | fines | fines | Mill | | house |
| | 0-3 mm | 3-6 mm | scale | Slurry | dust |
| Fe [symbol] | 63.1 | 65.8 | 70.1 | 60.2 | 28.3 |
| Fe₃O₄² | 5.5 | 4.32 | 21.6 | 37.9 | 25.8 |
| Fe²⁺ | 2.6 | 0.85 | 46.5 | 12.8 | 9.1 |
| Fe¹ | | | 0.44 | 5.2 | |
| SiO₂ | 2.3 | 1.2 | 0.52 | 2.7 | 4.9 |
| CaO | 0.86 | 0.78 | 0.18 | 2.7 | 6.0 |
| MgO | 0.41 | 0.46 | 0.029 | 0.95 | 5.5 |
| Al₂O₃ | 0.81 | 0.33 | 0.084 | 1.6 | 0.84 |
| C | 0.22 | 0.06 | 0.21 | 1.8 | 1.2 |
| S | 0.05 | 0.02 | 0.02 | 0.03 | 0.45 |
| Na | | | | 0.028 | 3.6 |
| K | | | | <0.01 | 2.8 |
| Zn | | | | <0.01 | 15.8 |
| C [symbol] | | | | 0.003 | 1.7 |
| F | | | | 0.069 | 0.0945 |
| H₂O_{crystal} [symbol] | | | | 3.0 | 2.4 |
| Loss of | | | | 8.2 | 14.2 |
| ignition | | | | | |

[symbol]

indicates data missing or illegible when filed

In another aspect, a fine iron oxide can comprise a composition such as that detailed in Table 2, below.

TABLE 2
Iron Oxide Composition as Determined by X-Ray Fluorescence

| Oxide | Conc. Wt. % | Element | Conc. Wt. % |
|---|---|---|---|
| C | 0.0772 | C | 0.42 |
| MgO | 0.093 | Mg | 0.056 |
| Al₂O₃ | 0.19 | Al | 0.1 |
| SiO₂ | 0.885 | Si | 0.414 |
| P₂O₅ | 0.205 | P | 0.0895 |
| S | 0.005 | S | 0.02 |
| K₂O | 0.014 | K | 0.012 |
| CaO | 1.02 | Ca | 0.729 |
| TiO₂ | 0.0396 | Ti | 0.0237 |
| MnO | 0.0664 | Mn | 0.0514 |
| Fe₂O₃ | Balance | Fe | Balance |
| ZnO | 0.013 | Zn | 0.0104 |

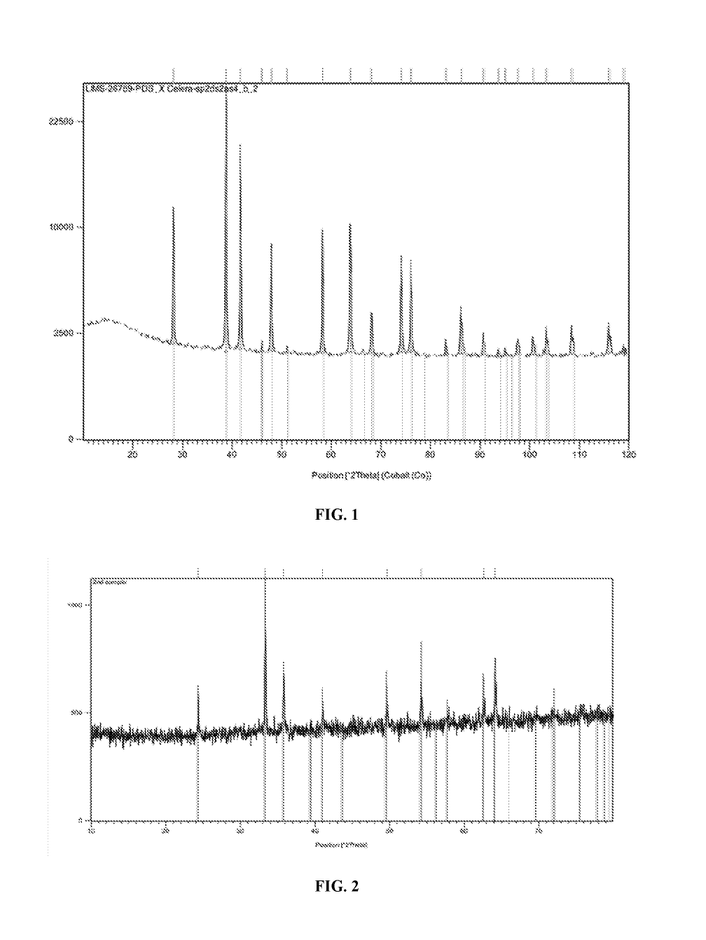

In other aspects, the particle size of an iron containing by-product can vary, depending on the source of the by-product. In various aspects, the particle size of the iron containing by-product can be about 10 mm or less, about 8 mm or less, 6 mm or less, about 5 mm or less, about 4 mm or less, or about 2 mm or less. Exemplary particle sizes are detailed in Table 3, below. It should be noted that particle sizes are typically a distributional property and that a sample having an average particle size can typically comprise a range of individual particle sizes. FIGS. 1 and 2 illustrate exemplary X-Ray Diffraction (XRD) patterns.

TABLE 3
Exemplary Particle Distributions
for Iron Containing By-Products

| Screen | Undersize, % | |
|---|---|---|
| Size | Oxide pellet | Oxide pellet |
| (mm) | fines (0-3 mm) | fines (3-6 mm) |
| 8.00 | | 100.00 |
| 6.73 | | 99.40 |
| 6.00 | 100.00 | 95.73 |
| 4.76 | 99.65 | 53.93 |
| 3.35 | 96.09 | 4.96 |
| 2.36 | 75.11 | 2.65 |
| 1.70 | 54.62 | 2.58 |
| 1.18 | 47.36 | |
| 0.850 | 43.69 | |
| 0.600 | 40.71 | |
| 0.500 | | |
| 0.425 | 39.11 | |
| 0.300 | 37.74 | |
| 0.212 | 36.22 | |
| 0.150 | 34.98 | |
| 0.106 | | |
| 0.075 | 32.79 | |
| 0.053 | | |
| 0.044 | | |
| 0.038 | 27.31 | |
| 0.020 | | |
| 0.010 | | |
| 0.005 | | |
| 0.003 | | |
| 0.002 | | |
| 0.001 | | |
| 0.0005 | | |

The metal oxide can comprise any metal oxide suitable for use in preparing a soft ferrite. In one aspect, the metal oxide can comprise a nickel oxide. In another aspect, the metal oxide can comprise a magnesium oxide. In yet another aspect, the metal oxide can comprise a zinc oxide. In another aspect, the metal oxide can comprise two or more individual metal oxides or a mixture thereof. The purity of a metal oxide can vary, provided that such a metal oxide is suitable for use in preparing a soft ferrite as described herein. In one aspect, the metal oxide is pure or substantially pure. In another aspect, the metal oxide can be analytical grade. In one aspect, the purity of a metal oxide is at least about 80%, at least about 85%, at least about 90%, at least about 95%, or greater. In another aspect, the purity of a metal oxide is at least about 96%, at least about 97%, at least about 98%, at least about 99%, at least about 99.5%, or greater.

The size and composition of a metal oxide or mixture of metal oxides can vary, for example, depending on the desired properties of the resulting soft ferrite. Metal oxides are commercially available and one of skill in the art, in possession of this disclosure, could readily select an appropriate metal oxide for use in the methods described herein.

The molar ratio of metal from the metal oxide, for example, nickel, magnesium, and/or zinc, to iron can vary. In various aspects, the molar ratio of metal (i.e., from the metal oxide) to iron can range from about 0.75:2 to about 1.5:2, for example, 0.75:2, 0.8:2, 0.85:2, 0.9:2, 0.95:2, 1:2, 1.05:2, 1.1:2, 1.15:2, 1.2:2, 1.25:2, 1.3:2, 1.35:2, 1.4:2, 1.45:2, or 1.5:2. In another aspect, the molar ratio of metal to iron can be about 1:2 or about 1.1:2.

In one aspect, the metal oxide and the iron containing by-product can be contacted. In another aspect, the metal oxide and the iron containing by-product can be mixed so as to achieve a uniform or substantially uniform mixture.

In another aspect, the iron containing by-product and/or the metal oxide can optionally be milled and/or ground prior to contacting. In one aspect, the iron containing by-product can be finely ground prior to mixing with a stoichiometric amount of analytical grade nickel oxide. In another aspect, the iron containing by-product can be finely ground prior to mixing with analytical grade nickel oxide at a molar ratio (Ni:Fe) of 1:2 or 1.1:2.

After contacting, the metal oxide and iron containing by-product can be mixed, for example, in a ball mill for about a period of time, for example, about 2 hours. The mixture can then be dried, for example, at about 100° C. for a period of time, for example, from about 3 hours to about 48 hours, for example, about 3, 4, 5, 8, 10, 12, 14, 16, 18, 20, 24, 28, 32, 36, 40, 44, or 48 hours, or overnight.

The mixture of metal oxide and iron containing by-product, for example, iron oxide dust, can then be calcined to form a ferrite material. In one aspect, the mixture of metal oxide and iron containing by-product can be heated at a rate of about 10° C./min in a static air atmosphere up to a desired annealing temperature. In various aspects, the annealing temperature can range from about 1,000° C. to about 1,500° C., for example, about 1,000° C., about 1,100° C., about 1,200° C., about 1,300° C., about 1,400° C., or about 1,500° C. Once the desired annealing temperature is reached, the mixture can be held at the annealing temperature for a period of time, for example, about 2 hours.

In one aspect, the mixture of metal oxide and iron containing by-product is not subjected to one or more of an oxidation step or a compacting step prior to calcining. In another aspect, the mixture of metal oxide and iron containing by-product is not subjected to an oxidation step or a compacting step prior to calcining.

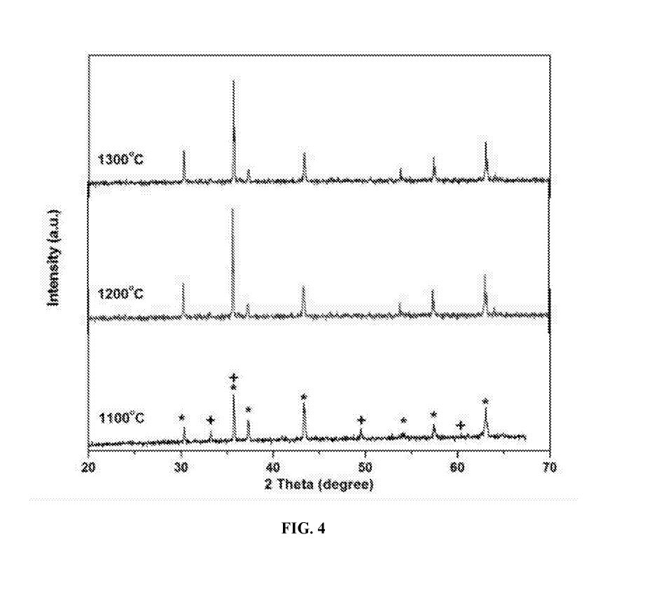

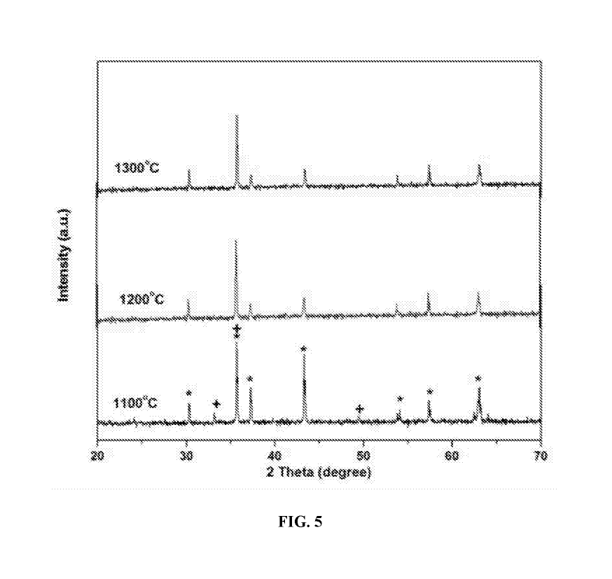

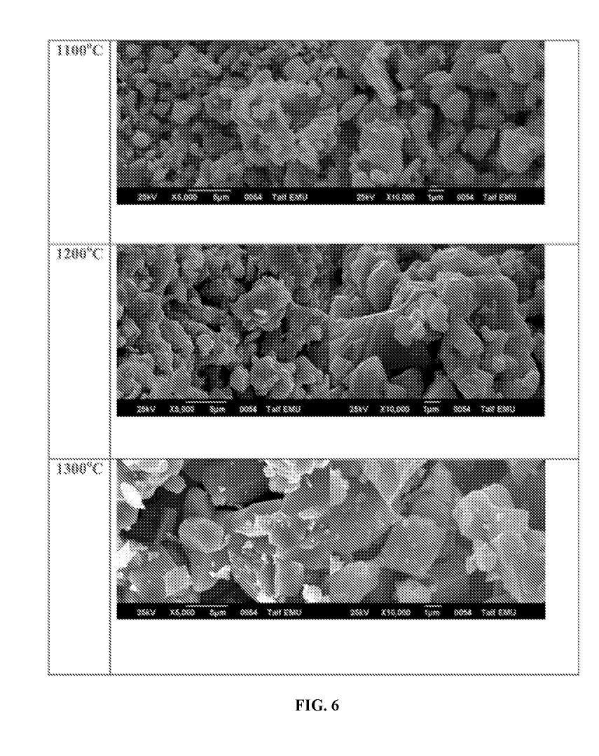

Depending on the annealing time and temperature, the resulting ferrite material can exhibit impurities, such as, for example α-Fe₂O₃. In one aspect, such impurities can be present when annealing temperatures of 1,100° C. or less are utilized. FIG. 4 illustrates exemplary XRD patterns for a resulting NiFe₂O₄ powder prepared with a molar ratio (Ni:Fe) of 1:2 at various annealing temperatures. Similarly, FIG. 5 illustrates exemplary XRD patterns for a resulting NiFe₂O₄ powder prepared with a molar ratio (Ni:Fe) of 1.1:2 at various annealing temperatures.

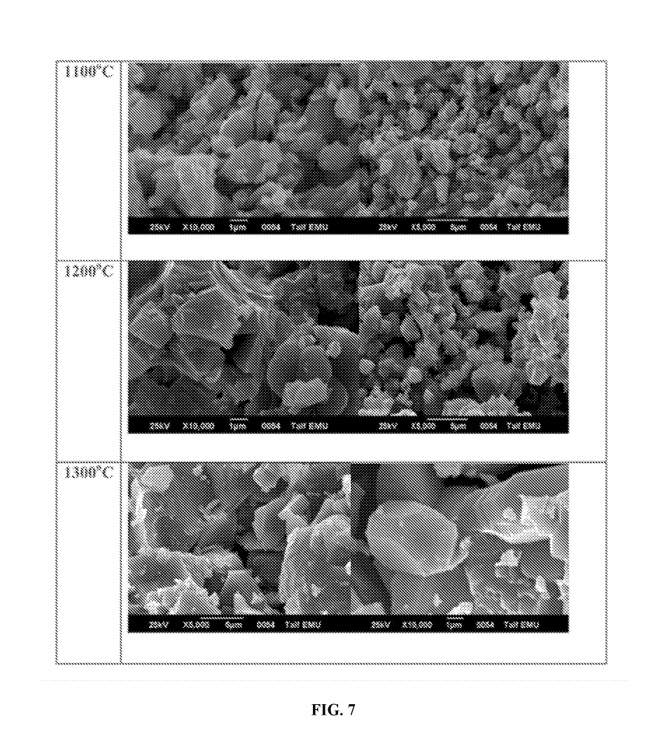

The microstructure of the resulting ferrite materials are illustrated in FIG. 6 (Ni:Fe=1:2) and FIG. 7 (Ni:Fe=1.1:2). Ferrite materials annealed at 1,100° C. can exhibit irregular microstructures with a mixture of large and small particles. Ferrite materials annealed at 1,200° C. or above can exhibit a uniform structure with a crystalline microstructure. In another aspect, grain size can increase at increased annealing temperatures. In one aspect, the ferrite can exhibit a single phase, for example, NiFe₂O₄. In another aspect, the ferrite can exhibit a homogeneous microstructure. In yet another aspect, the ferrite can exhibit a uniform or relatively uniform size distribution. In another aspect, the ferrite does not comprise an a-Fe₂O₃ phase.

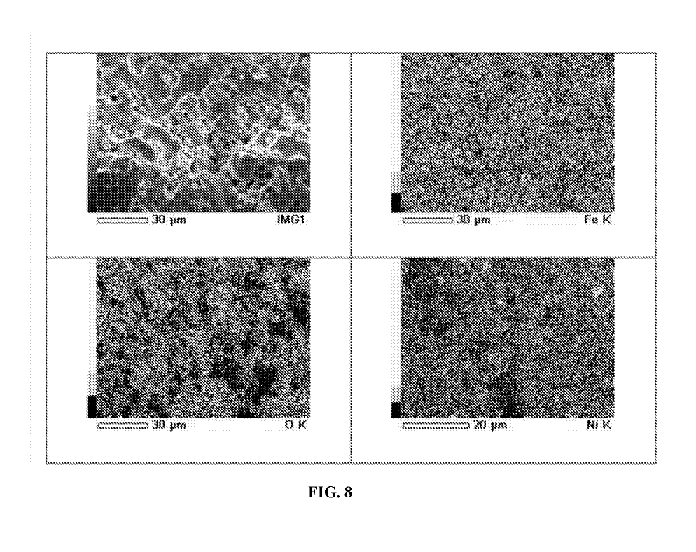

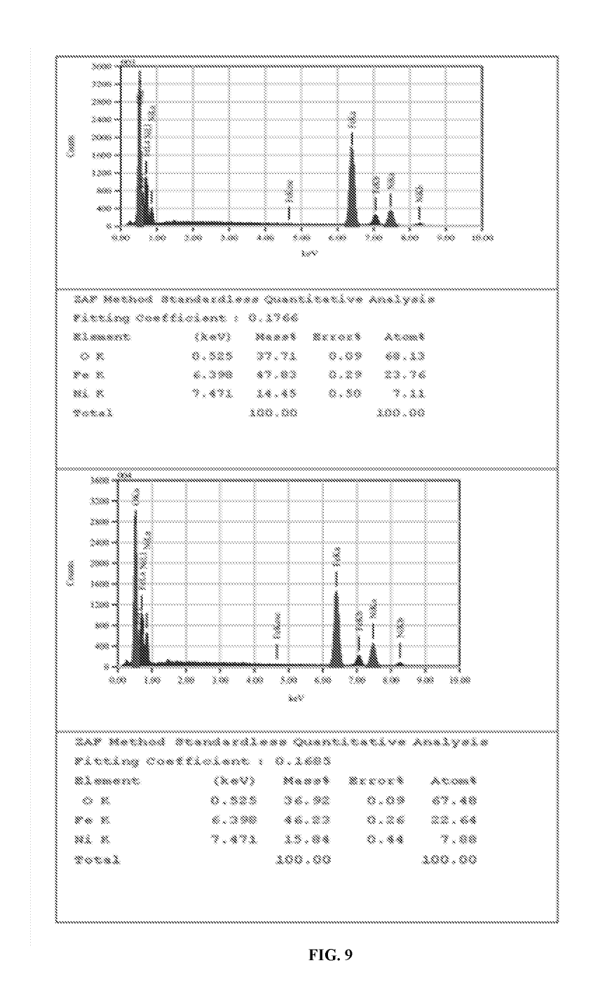

In addition, the distribution of elements (i.e., Fe, Ni, O) within a ferrite material can be determined by, for example, energy dispersive x-ray analysis (EDX). In one aspect, the distribution of Fe, Ni, and O in a ferrite material can be uniform or substantially uniform, such that the resulting ferrite material exhibits a homogeneous microstructure. FIGS. 8 and 9 illustrate microstructure maps and spot analysis data for a nickel ferrite prepared with a molar ratio (Ni:Fe) or 1.1:2 and an annealing temperature of 1,300° C.

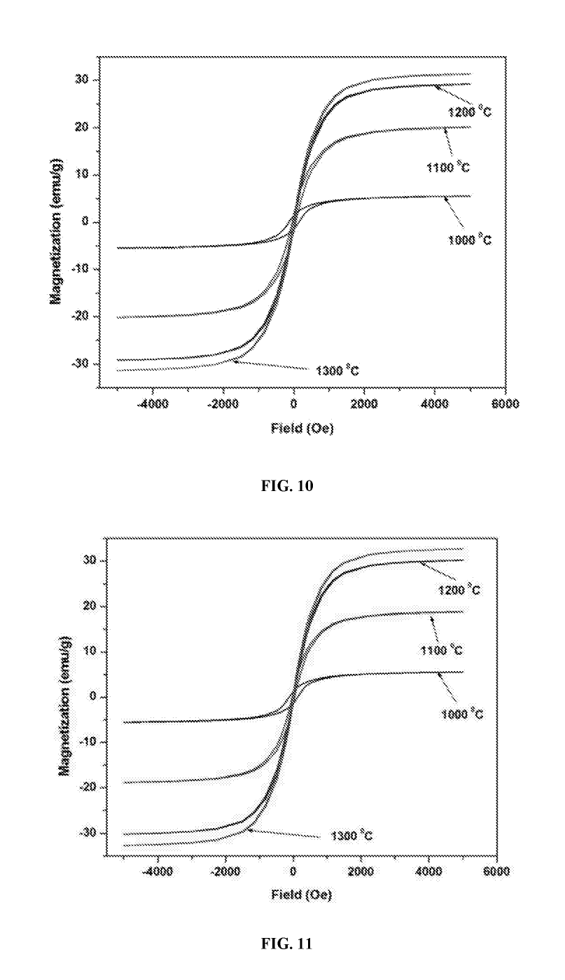

The resulting ferrite materials can be magnetized at room temperature under an applied field of, for example, 5 KOe, wherein hysteresis loops can be obtained. Exemplary plots of magnetization (M) as a function of the applied field (H) for a nickel ferrite having a molar ratios (Ni:Fe) of 1:2 and 1.1:2 at various annealing temperatures are illustrated in FIGS. 10 and 11, respectively. In one aspect, the resulting soft ferrite can exhibit a magnetization of at least about 10 emu/g, at least about 15 emu/g, at least about 20 emu/g, at least about 25 emu/g, or at least about 30 emu/g. In another aspect, a nickel ferrite can exhibit a magnetization of 32.6 emu/g for a single phase annealed at 1,300° C.

In other aspects, a ferrite of the present invention, for example, NiFe₂O₄ ferrite, or a composition comprising a ferrite of the present invention, can be used in one or more of power electronics, ferrite antennas, magnetic recording heads, magnetic intensifiers, data storage cores, filter inductors, wideband transformers, power/current transformers, magnetic regulators, driver transformers, wave filters, cable EMI, or a combination thereof. In one aspect, a NiFe₂O₄ ferrite can comprise a core material for one or more of the devices and/or applications described above. In another aspect, an article of manufacture can comprise the ferrite of the present invention.

The methods and compositions of the present disclosure can be described in a number of exemplary and non-limiting aspects, as detailed below.

Aspect 1: A method for preparing soft cubic ferrites of a general formula MFe₂O₄ comprising:
a) contacting an iron containing by-product of iron ore processing and a metal oxide of the general formula MₓO_{y} to form a mixture, wherein the stoichiometric ratio of M to iron is in the range from greater than zero to about 2, and wherein M is nickel, magnesium, or zinc, or a combination thereof; and
b) calcining the mixture at a temperature range of from about 1000° C. to about 1,500° C. in a static air atmosphere, to form a soft cubic ferrite of a general formula MFe₂O₄, wherein the mixture is not subjected to an oxidation step or a compacting step prior to calcining.

Aspect 2: The method of aspect 1, wherein M is nickel.

Aspect 3: The method of aspect 1, wherein the iron containing by product of iron ore processing comprises iron oxide dust.

Aspect 4: The method of aspect 3, wherein the iron oxide dust comprises oxides of Fe(II), Fe(III), or Fe(II/III), or any combination thereof.

Aspect 5: The method of aspect 3, wherein the iron oxide dust comprises at least 68 wt % of iron.

Aspect 6: The method of aspect 1, wherein the iron oxide is ground prior to contacting with the metal oxide.

Aspect 7: The method of aspect 1, wherein the contacting is performed for at least 2 hours.

Aspect 8: The method of aspect 1, further comprising step of drying the mixture prior to calcination.

Aspect 9: The method of aspect 8, wherein drying is performed at a temperature of at least 100° C., for a period of time from about 3 to about 48 hours.

Aspect 10: The method of aspect 1, wherein the calcining temperature is at least about 1200° C.

Aspect 11: The method of aspect 1, wherein the calcining temperature is at least about 1300° C.

Aspect 12: The method of aspect 1, wherein calcining comprises heating at a rate of about 10° C./min.

Aspect 13: A NiFe₂O₄ ferrite prepared by the method of any aspects 1-12.

Aspect 14: The NiFe₂O₄ ferrite of aspect 13, comprising a single NiFe₂O₄ phase exhibiting a homogeneous microstructure and a uniform size distribution.

Aspect 15: The NiFe₂O₄ ferrite of aspect 13 does not comprise impurities of a-Fe₂O₃ phase.

Aspect 16: The NiFe₂O₄ ferrite of aspect 15, wherein the NiFe₂O₄ ferrite exhibits maximum saturation magnetization of at least 20 emu/g.

Aspect 17: The NiFe₂O₄ ferrite of aspect 15, wherein the NiFe₂O₄ ferrite exhibits maximum saturation magnetization of at least 25 emu/g.

Aspect 18: The NiFe₂O₄ ferrite of aspect 15, wherein the NiFe₂O₄ ferrite exhibits maximum saturation magnetization of at least 30 emu/g.

Aspect 19: The NiFe₂O₄ ferrite of aspect 15, wherein the NiFe₂O₄ ferrite exhibits maximum saturation magnetization of at least 32 emu/g.

Aspect 20: A composition comprising the NiFe₂O₄ ferrite of any of aspects 13-19.

Aspect 21: An article of manufacture comprising the ferrite of any of aspects 13-19.

Aspect 22: The composition of aspect 20, comprising core materials for power electronics, ferrite antennas, magnetic recording heads, magnetic intensifiers, cores for data storage, filter inductors, wideband transformers, power/current transformers, magnetic regulators, driver transformers, wave filters, or cable EMI.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Example 1

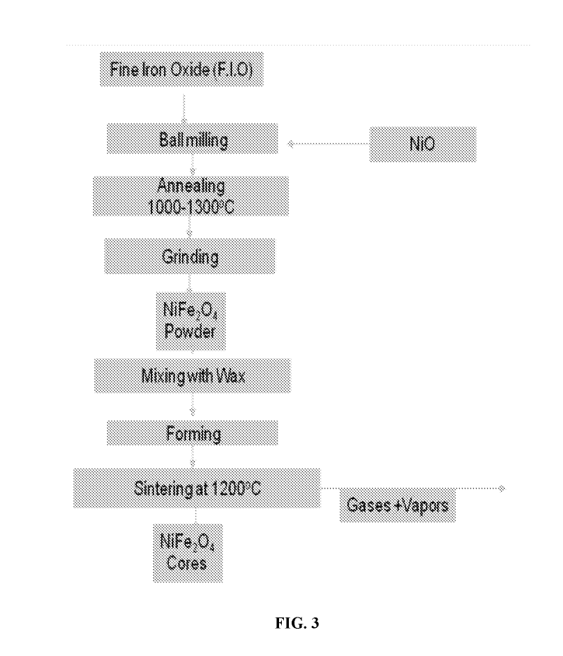

In a first example, a fine iron oxide sample with about 68% total iron was finely ground and thoroughly mixed with a stoichiometric amount of analytical grade nickel oxide. Two series of fine iron oxide and nickel oxide with various Ni:Fe molar ratios 1:2 and 1.1:2 were prepared. The pre-calculated stoichiometric ratios of fine iron oxide and NiO were mixed in a ball for 2 h and then dried at 100° C. overnight. For the formation of the Ni ferrite phase, the dried precursors were calcined at a rate of 10° C./min in static air atmosphere up to the required annealed temperature and maintained at the temperature for the annealing time in the muffle furnace. The effect of annealing temperature (1000, 1100, 1200 and 1300° C.) on the formation of Ni ferrite was studied while the annealing time was constant and kept 2 hours (FIG. 3).

The crystalline phases present in the different samples were identified by X-ray diffraction (XRD) in the range 20 from 10° to 80°. The ferrites particles morphologies were observed by scanning electron microscope (SEM, JSM-5400). The magnetic properties of the ferrites were measured at room temperature using a vibrating sample magnetometer (VSM; 9600-1 LDJ, USA) in a maximum applied field of 5 kOe. From the obtained hysteresis loops, the saturation magnetization (Ms), Remnant Magnetization (Mr) and Coercivety (Hc) were determined.

### 2. Example 2

In a second example, the resulting nickel ferrite materials were magnetized. Magnetization of the produced nickel ferrite powders was performed at room temperature under an applied field of 5 KOe and the hysteresis loops of the ferrite powders were obtained. Plots of magnetization (M) as a function of applied field (H) per Mg/Fe mole ratio and annealing temperature were shown in FIGS. 10-11 for the effect of annealing temperature (1,000° C.-1,300° C.) at Ni:Fe=1:2 and 1.1:2, respectively. In general, the nickel ferrite was a soft magnetic material due to the deviation from rectangular form and the low coercivity and the magnetic properties of the prepared nickel ferrites are strongly dependent on the annealing temperature but not on the Ni ion concentration. It was observed that no significant difference in the saturation magnetization (Ms) occurred between Ni:Fe=1:2 and Ni:Fe=1.1:2. Such high saturation magnetization for Ni ferrite annealing at 1,300° C. can be attributed to the high phase purity and well-defined crystallinity of NiFe₂O₈. The increase in the saturation magnetization by increasing the annealing temperature was due to the increase of phase purity and well-defined crystallinity of NiFe₂O₈. These results were in agreement with those observed in XRD results.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for preparing soft cubic ferrites of a general formula MFe₂O₄ comprising:
a) contacting an iron containing by-product of iron ore processing and a metal oxide of the general formula MxOy to form a mixture, wherein the stoichiometric ratio of M to iron is in the range from greater than zero to about 2, and wherein M is nickel, magnesium, or zinc, or a combination thereof; and
b) calcining the mixture at a temperature range of from about 1000° C. to about 1,500° C. in a static air atmosphere, to form a soft cubic ferrite of a general formula MFe₂O₄, wherein the mixture is not subjected to an oxidation step or a compacting step prior to calcining.

2. The method of claim 1, wherein M is nickel.

3. The method of claim 1, wherein the iron containing by product of iron ore processing comprises iron oxide dust.

4. The method of claim 3, wherein the iron oxide dust comprises oxides of Fe(II), Fe(III), or Fe(II/III), or any combination thereof.

5. The method of claim 3, wherein the iron oxide dust comprises at least 68 wt % of iron.

6. The method of claim 1, wherein the iron oxide is ground prior to contacting with the metal oxide.

7. The method of claim 1, wherein the contacting is performed for at least 2 hours.

8. The method of claim 1, further comprising step of drying the mixture prior to calcination.

9. The method of claim 8, wherein drying is performed at a temperature of at least 100° C., for a period of time from about 3 to about 48 hours.

10. The method of claim 1, wherein the calcining temperature is at least about 1200° C.

11. The method of claim 1, wherein the calcining temperature is at least about 1300° C.

12. The method of claim 1, wherein calcining comprises heating at a rate of about 10° C./min.

13. A ferrite, wherein the ferrite comprises NiFe₂O₄ ferrite prepared by the method of claim 1.

14. The NiFe₂O₄ ferrite of claim 13, comprising a single NiFe₂O₄ phase exhibiting a homogeneous microstructure and a uniform size distribution.

15. The NiFe₂O₄ ferrite of claim 13, wherein the ferrite is essentially free of impurities of a-Fe₂O₃ phase.

16. The NiFe₂O₄ ferrite of claim 15, wherein the NiFe₂O₄ ferrite exhibits maximum saturation magnetization of at least 20 emu/g or at least 25 emu/g.

17. (canceled)

18. The NiFe₂O₄ ferrite of claim 15, wherein the NiFe₂O₄ ferrite exhibits maximum saturation magnetization of at least 30 emu/g or at least 32 emu/g.

19. (canceled)

20. A composition comprising the NiFe₂O₄ ferrite of claim 13.

21. An article of manufacture comprising the ferrite of claim 13.

22. The composition of claim 20 comprising core materials for power electronics, ferrite antennas, magnetic recording heads, magnetic intensifiers, cores for data storage, filter inductors, wideband transformers, power/current transformers, magnetic regulators, driver transformers, wave filters, or cable EMI.
